(19) United States
(12) Patent Application Publication
(10) Pub. No.: US 2012/0249577 A1
(43) Pub. Date: Oct. 4, 2012

(54) DISPLAY APPARATUS AND METHOD

(75) Inventor: Atsushi SUKENORI, Tokyo (JP)

(73) Assignee: CASIO COMPUTER CO., LTD., Tokyo (JP)

(21) Appl. No.: 13/432,634

(22) Filed: Mar. 28, 2012

(30) Foreign Application Priority Data
Mar. 30, 2011 (JP) 2011-076883

(51) Int. Cl. G09G 5/00

(52) U.S. Cl. 345/619

(57) ABSTRACT

A display apparatus includes: an image storage section that stores plural images; an image conversion section that selects an image from among the plural images and obtains a conversion image by converting the selected image; a schedule setting section that sets a schedule indicating an order and timings of displaying the plural images stored in the image storage section and the conversion image obtained by the image conversion section; a display section that sequentially displays the plural images and the conversion image in the order and the timings according to the schedule set by the schedule setting section; and a controller that controls the image conversion section to complete the conversion of the selected image before a display start timing of the conversion image, the display start timing set by the schedule setting section.

### CROSS REFERENCE TO RELATED APPLICATION(S)

The present disclosure relates to the subject matters contained in Japanese Patent Application No. 2011-076883 filed on Mar. 30, 2011, which are incorporated herein by reference in its entirety.

### BACKGROUND

1. Field

One of more embodiments of the present invention relate to a display apparatus and a method, especially, a slide show technique of processed images.

2. Description of the Related Art

A display apparatus called a digital photo frame is known which stores plural digital still images and performs a slide show by switching between them sequentially.

Images displayed in this display apparatus are images took by a digital camera, images previously incorporated in a body of the display apparatus, images received via Internet or a memory card, or the like.

Further, images displayed in this display apparatus may be processed original images. An example of the processing is converting an original image to a painterly image.

Among display apparatuses are ones which have a music or voice etc. playing function and perform a slide show while switching the displayed image in synchronization with to the music or voice played.

For instance, JP-A-2002-281440 discloses a digital photo frame in which images and voice data are correlated with each other and which displays a next image upon completion of play of one piece of voice data.

Further, JP-A-2007-188561 discloses a technique in which images and musical data are correlated with each other and which switches images in synchronization with melody change timing of the music.

Related-art digital photo frames merely display stored images with switching is made between them in order and hence the display may be less interesting or surprising.

Further, although JP-A-2007-288561 shows concepts of changing timings for reproducing images in synchronization with changing points of melody of the music, such as changing points of phrases of an intro, a verse, a bridge, a chorus, an interlude, or the like, processing images are not assumed.

That is to say, since processing images into painterly images etc. require time, the image processing may not complete by the changing point of melody of the music. Therefore, ongoing music and switching timings of images to be displayed may not be synchronized.

The present invention has been made in view of the above, and an object of one or more embodiments of the invention is therefore to provide a display apparatus and a display method which can synchronize display of original images and processed images and ongoing timings of timing signals while a slide show of processed images in synchronization with certain timing signals.

### SUMMARY

According to a first aspect of the embodiments, there is provided a display apparatus including: an image storage section that stores plural images; an image conversion section that selects an image from among the plural images and obtains a conversion image by converting the selected image; a schedule setting section that sets a schedule indicating an order and timings of displaying the plural images stored in the image storage section and the conversion image obtained by the image conversion section; a display section that sequentially displays the plural images and the conversion image in the order and the timings according to the schedule set by the schedule setting section; and a controller that controls the image conversion section to complete the conversion of the selected image before a display start timing of the conversion image, the display start timing set by the schedule setting section.

According a second aspect of the embodiments, there is provided display method including: generating signals in predetermined timings and outputting timing signals having a pausing interval for pausing outputting of the signals for a certain period; sequentially selecting original images, from among plural original images, to be displayed in synchronization with the outputting of the timing signals; displaying a conversion image obtained by converting an original image from among the selected original images in a specific output timing of the timing signals; and displaying the selected original images in timings other than the specific output timing.

### BRIEF DESCRIPTION OF THE SEVERAL VIEWS OF THE DRAWINGS

FIG. 1 is a block diagram of a display apparatus according to a first embodiment of the present invention.

FIG. 2 outlines operations performed by the display apparatus according to the first embodiment.

FIG. 3 shows the structure of musical data according to the first embodiment.

FIG. 4 is a flowchart of a slide show execution preprocess according to the first embodiment.

FIG. 5 is a flowchart of a slide show execution process according to the first embodiment.

FIG. 6 is a flowchart of a slide show execution preprocess according to a second embodiment of the invention.

FIG. 7 shows the structure of image conversion program information used according to the second embodiment.

FIG. 8 is a block diagram of the display apparatus according to a third embodiment of the invention.

FIG. 9 outlines operations performed by the display apparatus according to the third embodiment.

FIG. 10 is a flowchart of a slide show execution preprocess according to the third embodiment.

FIG. 11 shows the structure of image conversion program information according to the third embodiment.

FIGS. 12A and 12B show processing for gradual display switching to a conversion image which is a modification to each of the first to third embodiments of the invention.

FIG. 13 is a block diagram showing an example hardware configuration of each of the display apparatus according to the first to third embodiments of the invention.

### DETAILED DESCRIPTION

Modes for carrying out the invention will be hereinafter described with reference to the drawings. In the drawings, the same items or items corresponding to each other are given the same reference symbol.

### First Embodiment

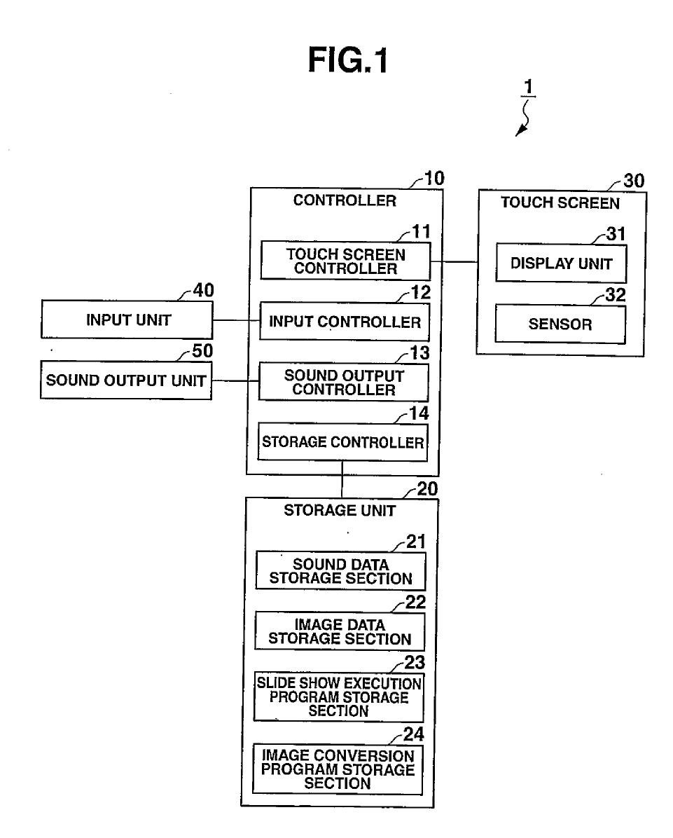

A display apparatus 1 according to a first embodiment of the invention is a digital photo frame having a function of displaying digital still images sequentially while playing previously stored music. As shown in FIG. 1, the display apparatus 1 is configured of a controller 10, a storage unit 20, a touch screen 30, an input unit 40, and a sound output unit 50.

The controller 10 is configured of a central processing unit (CPU), a digital signal processor (DSP), etc., operates according to programs stored in the storage unit 20, and controls the touch screen 30, the input unit 40, and the sound output unit 50. The controller 10 has a function of running plural programs in parallel by multitasking. Configured in this manner, in terms of functionality, the controller 10 is equipped with a touch screen controller 11, an input controller 12, a sound output controller 13, and a storage controller 14.

The touch screen controller 11 controls the touch screen 30. More specifically, the touch screen controller 11 causes a display unit of the touch screen 30 to display an image and receives information indicating a user manipulation that is detected by a sensor 32.

The input controller 12 receives information indicating a user manipulation that is made by the user through the input unit 40.

The sound output controller 13 causes the sound output unit 50 to output sounds according to a processing result of the controller 10. The sound includes a musical sound, a human voice, and other sounds.

The storage controller 14 controls the storage unit 20. More specifically, the storage controller 14 stores, in the storage unit 20, information corresponding to a processing result of the controller 10 and reads information stored in the storage unit 20.

Physically, the storage unit 20 is, for example, a nonvolatile memory such as a flash memory. In terms of functionality, the storage unit 20 is configured of a sound data storage section 21, an image data storage section 22, a slide show execution program storage section 23, and an image conversion program storage section 24.

The sound data storage section 21 stores musical data configured of note data and header information.

The image data storage section 22 stores image data of plural images such as photographs. An arbitrary image type and image data format can be employed. Images prior to conversion are referred to as original images, and Images subjected to conversion are referred to as conversion images. In the embodiment, images are taken photographs and are stored in the image data storage section 22 together with pieces of attribute information such as photographing dates and times.

The slide show execution program storage section 23 is stored with programs which allow the controller 10 to perform a slide show (described below).

The image conversion program storage section 24 is stored with image conversion programs which allow the controller 10 to perform image conversion as an example of processing. Although arbitrary image conversion program types can be employed, arbitrary existing image conversion programs can be employed such as i) a program for converting a photograph into a painterly image (oil-painting-like image or watercolor-painting-like image), ii) a program for determining a background portion of a photograph and replacing the background portion with another image, iii), a program for determining a human portion (s) in a photograph and modifying the human portion, and iv) a program for converting the hue, chrome, or lightness of all or part of the pixels of an image.

The touch screen 30 is a device for detecting a user manipulation of moving a finger or the like on the screen. The touch screen 30 is configured in such a manner that the sensor 32 (touch sensor) for detecting a manipulation of, for example, moving a finger or the like relative to an image specified by the touch screen controller 11 is laid on the display unit 31 for displaying the image. The touch screen 30 transmits information indicating a manipulation detected by the sensor 32 to the touch screen controller 11.

The input unit 40 is configured of plural keys and an input/output section for transmitting information indicating a key manipulation to the input controller 12.

The sound output unit 50 is configured of an input unit for receiving sound data supplied from the sound output controller 13 and speakers for generating a sound based on the received sound data.

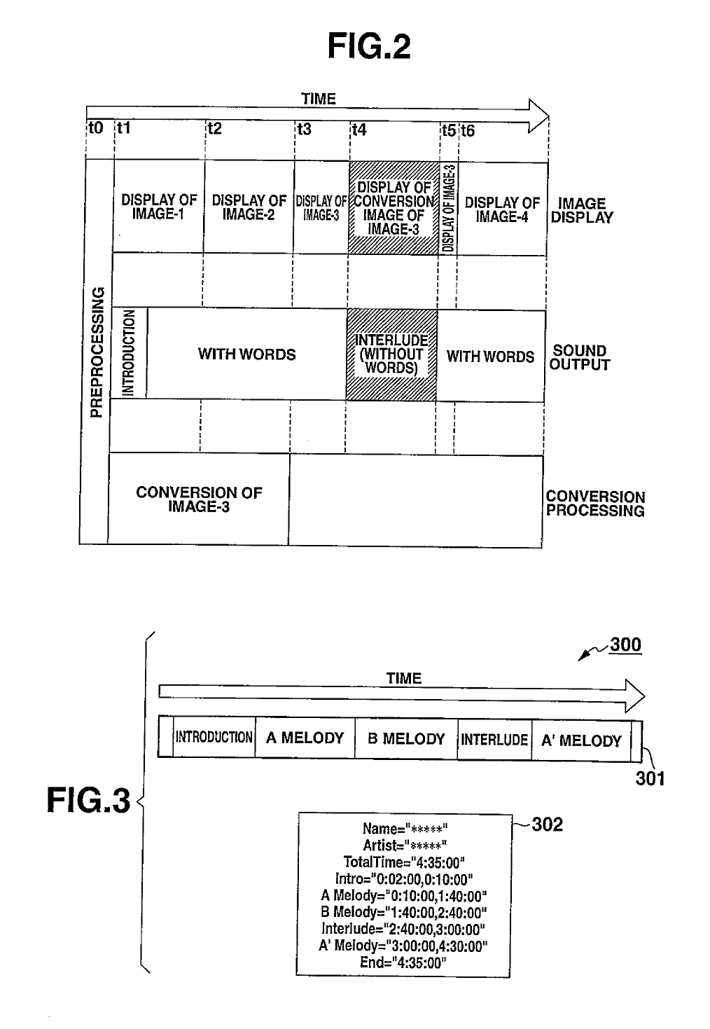

Next, operations that are performed by the display apparatus 1 will be outlined with reference to FIG. 2.

The display apparatus 1 performs a slide show, that is, sequentially displays plural images stored in the image data storage section 22 with switching is made between them while playing music based on musical data previously stored in the sound data storage section 21. More specifically, the display apparatus 1 displays original images such as image-1, image-2, and image-3 stored in advance while a lyrics-accompanied portion of a piece of music is played. While an interlude (a portion without lyrics) is played, the display apparatus 1 displays a conversion image that is an original image converted to a painterly image by the image conversion program, such as a conversion image of the image-3.

To makes such a display, the display apparatus 1 starts preprocessing as soon as it is booted (time t0). In the preprocessing, a schedule etc. of a slide show are determined. In this example, it is assumed that display subject images are image-1 to image-4.

First, the length (time) of a music excluding an interlude is determined and the determined time is divided by 4 to determine a display time t of each image.

Then, an image to be displayed immediately before a start of the interlude is determined. In the example of FIG. 2, image-3 is made an image to be displayed immediately before a start of the interlude.

To display, during the interlude, a conversion image obtained by converting image-3 by a prescribed method, processing of converting image-3 using a conversion program stored in the image conversion program storage section 24 is started. A resulting conversion image is a painterly image obtained by converting image-3.

Upon completion of the preprocessing, a slide show is started (time t1). More specifically, play of music that is stored in the sound data storage section 21 as BGM is started and image-1 is displayed on the display unit 31 according to a schedule.

As time elapses, the image displayed on the display unit 31 is switched from image-1 to image-2 (time t2) and from image-2 to image-3 (time t3). The intervals t2−t1 and t3−t2 are equal to t.

When the music has reached the interlude (time t4), the conversion image obtained by converting image-3 that was displayed immediately before is displayed.

Upon completion of the interlude (time t5), the slide show is restarted. In the restarted slide show, image-3 is displayed for a residual time (t−t4+t3). When image-3 has been displayed for the time t in total (time t6), image-4 starts to be displayed.

When image-4 has been displayed for the time t, the play of the music and the slide show are finished.

In the above-described operations, the slide show is started upon completion of the preprocessing. Then, processing of generating the conversion image of image-3 is started upon completion of the preprocessing and performed parallel with the slide show. Therefore, the slide show can be started without a delay that is equal to a time taken to convert image-3. Since the generation of the conversion image of image-3 has already been finished when the display of the conversion image is started at time t4, an advantage is obtained that no processing delay occurs at time t4. Furthermore, since the image display schedule and the conversion image display timing are determined automatically, the user need not make complicated setting manipulations in advance.

How the display apparatus 1 operates after completion of the above operations is determined by an initial setting or a user setting. This setting is arbitrary; various settings are possible such as a setting that the slide show should be performed repeatedly, a setting that a predetermined image should be displayed after completion of the slide show, and a setting that the display apparatus 1 should be powered off upon completion of the slide show.

The structure of musical data 300 that is stored in the sound data storage section 21 will be described below with reference to FIG. 3.

The musical data 300 is configured of plural phrase data 301, which configure the music, such as an intro, a first verse, a bridge, a chorus, and an interlude, and header information 302 which indicates constituent elements of the music. The header information 302 is contained in a header of the musical data 300.

The header information 302 is configured of a music name (“Name”), an artist name (“Artist”), a total music length (“TotalTime”), and information indicating positions of respective constituent elements in the music. In the example of FIG. 3, the phrase data 301 is configured of an introduction (“Intro”), an A melody (“First Verse”), a B melody (“Bridge”), an interlude (“Interlude”), and an A′ melody (“Second Verse”). In the header information 302, a start time and an end time are set for each of the constituent elements.

When the music starts to be played, the introduction is started after a lapse of two seconds from the start of the music (the origin of time measurement) and continues to 10 seconds. Then, the A melody is played from 10 seconds to one minute 40 seconds. Then, the B melody is played from one minute 40 seconds to two minutes 40 seconds. Then, the interlude is played from two minutes 40 seconds to three minutes 20 seconds. Upon completion of the interlude, the A′ melody which is a modified version of the A melody is played and the playing of the music is finished. The first and last portions where no constituent element is set are blank portions having no sounds.

The controller 10 extracts the header information from the header of the musical data 300 which is stored in the sound data storage section 21, and detects a portion of the music that is occupied by the interlude.

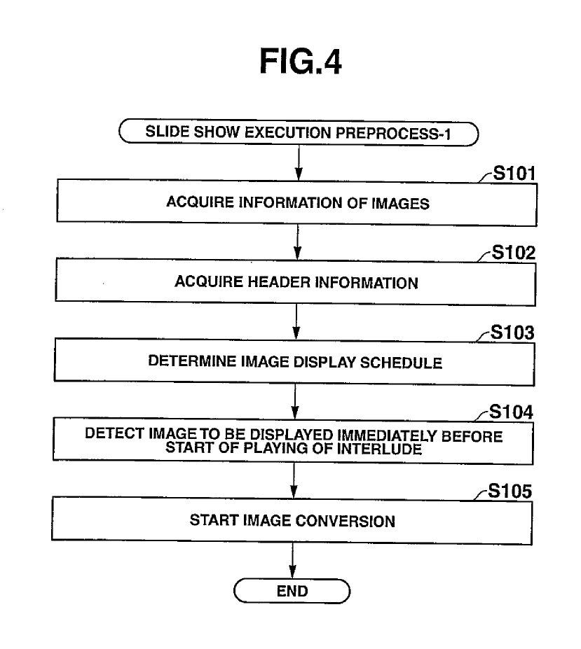

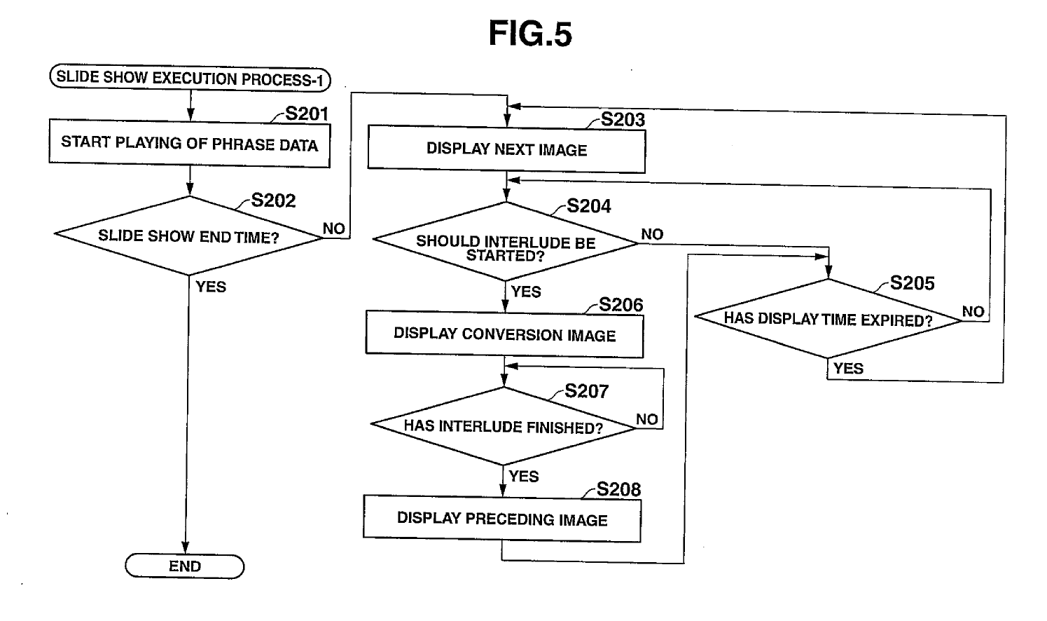

Next, how the display apparatus 1 performs the above operations will be described in a specific manner with reference to FIGS. 4 and 5.

Upon booting of the display apparatus 1, the controller 10 starts a slide show execution preprocess-1 shown in FIG. 4.

First, at step S101, the controller 10 acquires information of original images stored in the image data storage section 22. More specifically, the controller 10 acquires pieces of information indicating the number of stored images and photographing dates and times of the respective images.

At step S102, the controller 10 acquires the header information 302 of the musical data stored in the sound data storage section 21.

At step S103, the controller 10 determines an image display schedule from the header information 302 and the information relating to the images. More specifically, the controller 10 calculates a length of the music excluding the length of the interlude. Then, the controller 10 calculates a display time t per image by dividing the calculated length by the number of images, and determines a schedule so that a slide show will be performed in such a manner that the images will be displayed in order of the photographing date and time (an older image is displayed earlier) for the determined display time t except for the interlude period. In the example of FIG. 2, a schedule is determined so that image-1 will be displayed from time t1 to t2, image-2 will be displayed from time t2 to t3, image-3 will be displayed from time t3 to t4 and from time t5 to t6, and image-4 will be displayed from time t6 to the end of the music (each image will be displayed for the display time t).

At step S104, the controller detects an image to be displayed immediately before a start of playing of the interlude. In the example of FIG. 2, image-3 is detected.

Finally, at step S105, the controller 10 starts generation of a conversion image of the image detected at step S104. The conversion is performed by the controller 10 using the program stored in the image conversion program storage section 24.

Then, the slide show execution preprocess-1 is finished.

Upon completion of the slide show execution preprocess-1, the controller 10 starts a slide show execution process-1 shown in FIG. 5.

Upon the start of the slide show execution process-1, at step S201 the controller 10 starts playing of the phrase data 301 of the musical data 300 stored in the sound data storage section 21 and, at the same time, starts counting of a timer T1 for measuring the slide show execution time. The sound output controller 13 outputs sounds corresponding to the phrase data 301 using the sound output unit 50.

At step S202, the controller 10 judges, by referring to the timer T1, whether or not a slide show end time (music end time) has been reached.

If the slide show end time has been reached (S202: yes), the process is finished.

On the other hand, if the slide show end time has not been reached yet (S202: no), at step S203 the controller 10 causes display of the next image. Immediately after the start of the slide show, the first image is displayed. Furthermore, the controller 10 starts counting of a timer T2 for measuring the time for which the current display image has been displayed. If the timer T2 is already doing a counting operation, the controller 10 resets the count of the timer T2 and restarts counting of the timer T2.

As soon as the image is displayed, at step S204 the controller 10 judges, by referring to the timer T1, whether or not an interlude start time has been reached. If the interlude start time has been reached (S204: yes), the process moves to step S206 (described later).

On the other hand, if the interlude start time has not been reached (S204: no), at step S205 the controller 10 judges, by referring to the timer T2, whether or not the display time of the current display image has expired. More specifically, the controller 10 judges whether or not the measurement time of the timer T2 has exceeded the display time t of each image that was set at step S103 of the slide show execution preprocess-1. If the judgment result is affirmative, the controller 10 judges that the display time of the current display image has expired.

If the display time of the current display image has not expired yet (S205: no), the process returns to step S204. As step S204 is executed repeatedly, the current display image continues to be displayed until the interlude start time is reached or the display time expires.

On the other hand, if the display time of the current display image has expired (S205: yes), the process returns to step S202.

If it is judged that the interlude start time has been reached (S204: yes), at step S206 the controller 10 causes display of a conversion image of the image that has been displayed so far (i.e., the image that was detected at step S104 of the slide show execution preprocess-1). The controller 10 suspends the counting of the timer T2 for measuring the time for which the preceding image has been displayed.

The generation of a conversion image was started at step S105 of the slide show execution preprocess-1 (see FIG. 4) and a generated conversion image is stored in the storage unit 20. Since the controller 10 performs the processing of generating a conversion image parallel with the processing of displaying slide show images (see FIG. 2), the conversion image can be displayed without delay at step S206.

At step S207, the controller 10 judges, by referring to the timer T1, whether or not the interlude has finished. If the interlude has not finished yet (S207: no), the conversion image continues to be displayed until completion of the interlude. On the other hand, if the interlude has finished (S207: yes), at step S208 the image that was displayed before the start of the interlude is displayed. Furthermore, the controller 10 restarts the counting of the timer T2. The process returns to step S205 to continue the slide show.

The description of the slide show execution process-1 is finished here.

In the display apparatus 1 according to the embodiment, a conversion image that is different in style from an original image can be displayed during playing of an interlude stared in the sound data storage section 21 without requiring the user to make complicated preparatory manipulations. No waiting time for image conversion is necessary before or during a slide show. Furthermore, since image conversion has already been performed when a conversion image is displayed, the start of display of the conversion image is not deviated from the start of playing of the interlude. Therefore, an image that is different from any of stored images can be displayed without imposing stress on the user. The viewer may be surprised or interested. In this manner, it becomes possible to attract attention of the viewer.

### Second Embodiment

Next, a second embodiment of the invention will be described. The second embodiment has the same features as the first embodiment, and is further characterized in that in the slide show execution preprocessing a program for performing image conversion is selected according to a time to display of a conversion image.

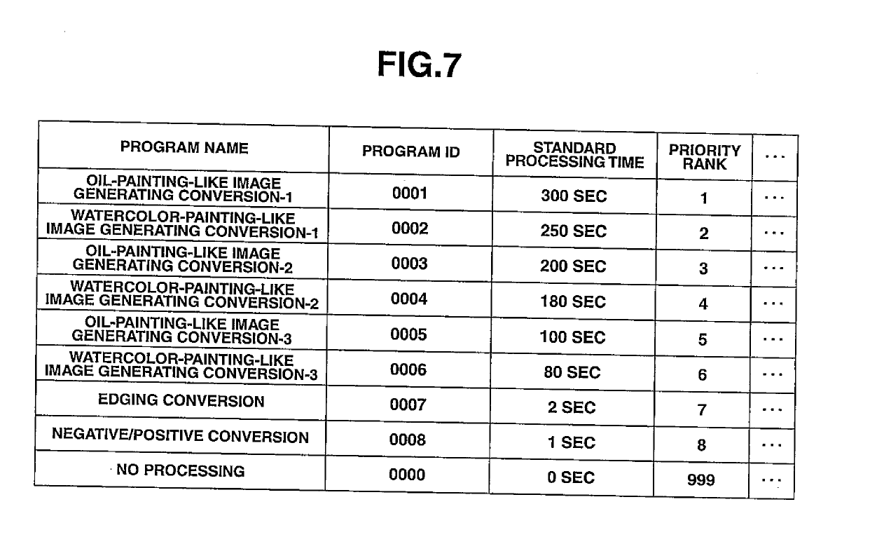

A display apparatus 2 according to the second embodiment is the same in configuration as the display apparatus 1 according to the first embodiment (see FIG. 1) except that the image conversion program storage section 24 is stored with plural image conversion programs as exemplified in FIG. 7 as well as a list (image conversion program information) of features (a standard processing time, a priority rank, etc.) of each of the plural image conversion programs.

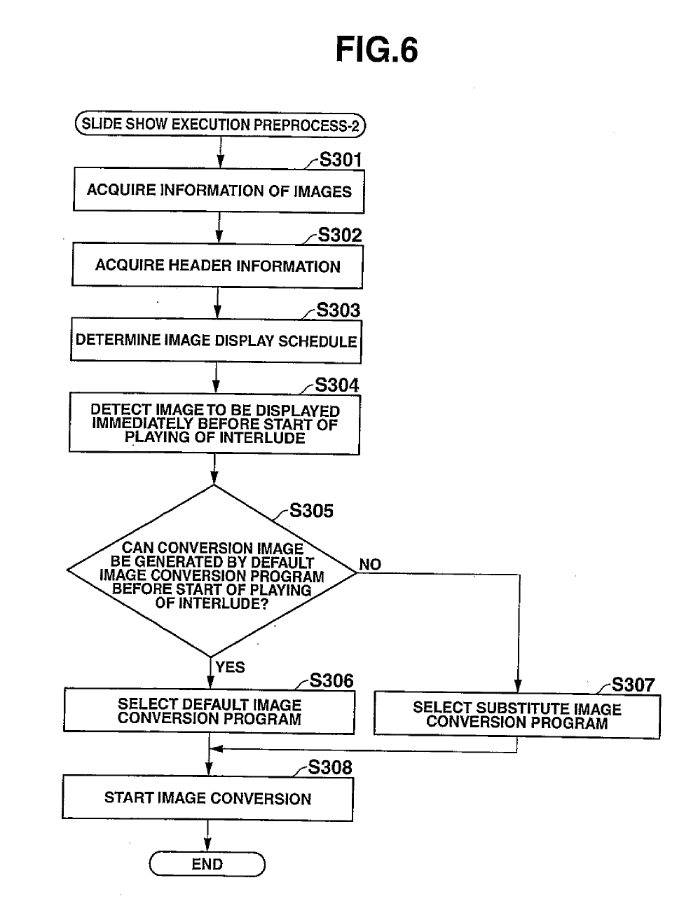

Next, a slide show execution preprocess-2 which is executed by the display apparatus 2 will be described with reference to FIG. 6.

Upon booting of the display apparatus 2, the controller 10 starts the slide show execution preprocess-2 shown in FIG. 6.

Step S301 (acquisition of information of images) to step S304 (detection of an image to be displayed immediately before a start of playing of the interlude) are the same as steps S101-S104 of the slide show execution preprocess-1 according to the first embodiment (see FIG. 4).

In the slide show execution preprocess-2, at step S305, the controller 10 judges whether or not a conversion image can be generated using a predetermined default image conversion program before a start of playing of the interlude. A specific judging method will be described later.

If judging that a conversion image can be generated before a start of playing of the interlude (S305: yes), at step S306 the controller 10 selects the default image conversion program.

On the other hand, if judging that a conversion image cannot be generated before a start of playing of the interlude (S305: no), at step S307 the controller 10 selects a substitute image conversion program. A specific selection method will be described later.

If an image conversion program is selected at step S306 or S307, at step S308 the controller 10 starts generation of a conversion image of the image detected at step S304 using the selected image conversion program.

Then, the slide show execution preprocess-2 is finished.

Upon completion of the slide show execution preprocess-2, a slide show is performed in the same manner as in the first embodiment (slide show execution process-1 shown in FIG. 5).

Now, how step S305 (judgment as to whether or not a conversion image can be generated using the predetermined default image conversion program before a start of play of the interlude; see FIG. 6) and step S307 (selection of a substitute image conversion program; see FIG. 6) are executed in the second embodiment will be described below in detail. These steps are executed based on the image conversion program information.

The structure of the image conversion program information will be described below with reference to FIG. 7. The image conversion program information is a list of features of each image conversion program and is stored in the image conversion program storage section 24.

In the list, a program name, a program ID, a standard processing time, a priority rank, etc. are correlated with each other for each image conversion program.

The program name is the name of the corresponding image conversion program.

The program ID is identification information (ID) that uniquely denotes the corresponding image conversion program.

The standard processing time is a rough measure of a processing time that is necessary for the corresponding image conversion program to perform image conversion processing. For example, the rough measure of a processing time is a standard time that is taken by the image conversion program to process image data (preferably, its size is adjusted in advance so as to be suitable for display by the display unit 31) stored in the image data storage section 22 and that is determined by an experiment or the like.

The priority rank is a numerical value (natural number) indicating a priority rank of the corresponding image conversion program. The priority rank is higher when the numerical value is smaller. The default image conversion program is an image conversion program whose priority rank is set at “1.”

At step S305 (see FIG. 6), the controller 10 compares a time from the present time to the interlude start time with a time (margin-added processing time) obtained by multiplying the standard processing time of the default image conversion program (i.e., the program having the priority rank “1”) by a safety factor. The safety factor is a numerical value that gives the processing time a certain margin and is determined in advance by an experiment or the like.

If the margin-added processing time is shorter than the time from the present time to the interlude start time, the controller 10 judges that a conversion image can be generated in time.

For example, where the safety factor is equal to 1.3 and whether to employ the program “oil-painting-like image generating conversion-1” (default image conversion program; see FIG. 7) is being considered, it is judged that a conversion image can be generated in time if the time to the interlude start time is longer than or equal to 390 seconds.

On the other hand, if the margin-added processing time is longer than the time to the interlude start time, the controller 10 selects a substitute image conversion program at step S307. More specifically, margin-added processing times of image conversion programs, other than the default program, registered in the image conversion program information are determined and compared with the time to the interlude start time in descending order of the priority rank (i.e., in ascending order of the numerical value). As a result, an image conversion program having a highest priority rank among programs whose margin-added processing times are shorter than the time to the interlude start time is selected as a substitute program.

To provide for a case that the time to the interlude start time is very short, the image conversion program information includes a row of “no processing.” Such a row is always given a largest numerical value (in the example of FIG. 7, “999”) indicating a priority rank in the list.

The above-described second embodiment provides, in addition to the advantages of the first embodiment, an advantage that an image generated by the best (i.e., highest priority) image conversion processing that can be performed within the time to an interlude start time can be displayed during the interlude. Since a most interesting image among images margin-added processing times for whose generation are shorter than the time to the interlude start time is displayed, the viewer may be surprised or feel interesting. In this manner, it becomes possible to attract attention of the viewer.

### Third Embodiment

Next, a third embodiment will be described.

The third embodiment is characterized by being configured so as to analyze an original image that is selected as a conversion source image after the start of a slide show and thereby select an optimum image conversion program.

Among image conversion programs are ones whose processing times vary to a large extent depending on the image even if the image size is kept the same.

For example, in the case of a program of converting a raster image into a vector image by extracting line portions from the former and thereby generating an image in which the line portions are converted into images as would be drawn with a paint brush, the processing time varies to a large extent depending on the number of vector elements contained in a conversion source image. The third embodiment is characterized in that even a conversion image generated using such an image conversion program (i.e., a program whose processing time varies to a large extent depending on the image) can be displayed with prescribed timing.

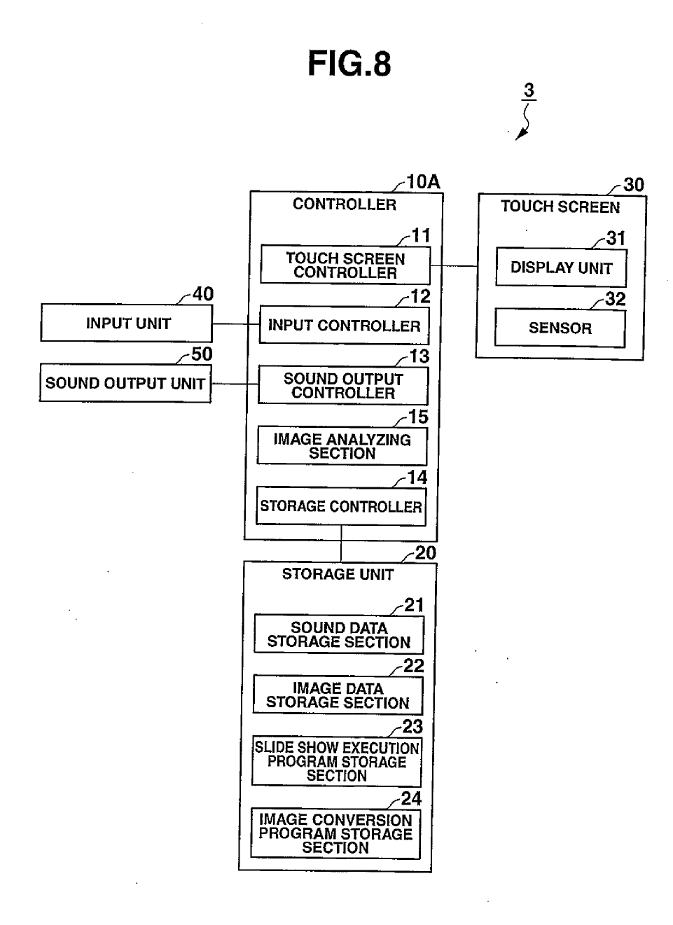

As shown in FIG. 8, a display apparatus 3 according to the third embodiment is different in configuration from the display apparatus 2 according to the second embodiment in that the controller 10A is equipped with an image analyzing section 15.

The image analyzing section 15 analyzes an image and estimates an approximate time to be taken by an image conversion program to convert the image.

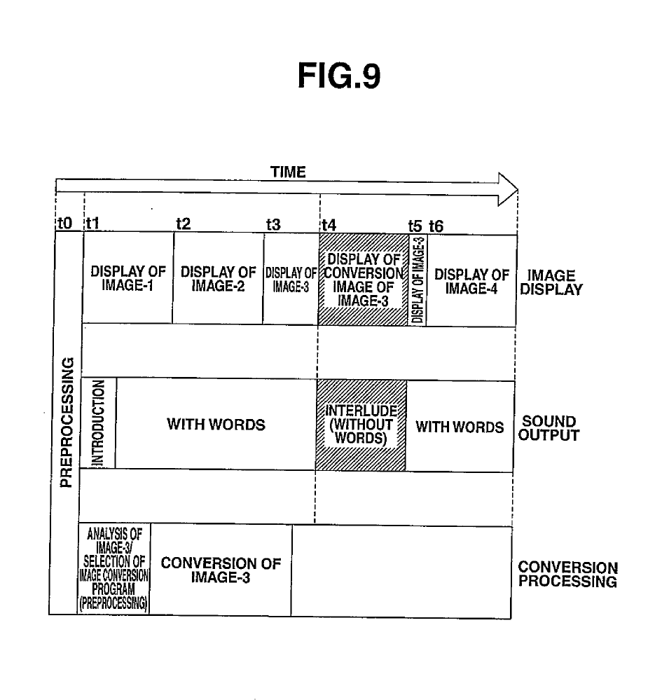

Operations that are performed by the display apparatus 3 according to the third embodiment will be described below with reference to FIG. 9. The operations performed by the display apparatus 3 according to the third embodiment are different from those performed by the display apparatus 1 and 2 according to the first and second embodiment in the preprocessing and the image conversion processing.

Upon booting of the display apparatus 3 (time t0) preprocessing is started to determine a slide show schedule etc.

In the third embodiment, image display and sound output are started (time t1) before determination of an image conversion program. Then, to select an image conversion program, processing of analyzing image-3 and program selection processing are performed parallel with the image display and sound output.

If it is judged that the time to the interlude start time is shorter than a prescribed threshold value (i.e., there isn't a sufficient time for analysis), no analysis processing is performed and the same operations as in the second embodiment are performed. More specifically, for example, the time to the interlude start time (time t4) is compared with a prescribed, experimentally determined threshold value (e.g., 1 minute) and no analysis processing is performed if the time to the interlude start time is shorter than the prescribed threshold value.

Upon completion of the analysis processing, a program for converting image-3 is determined and conversion of image-3 is started. The other operations are the same as in the first and second embodiments (see FIG. 2).

In the above-described operations, the analysis processing for selecting a program for converting image-3 is performed parallel with the slide show (image display and sound output). Therefore, the waiting time to the start of the slide show is not increased even if the analysis processing takes long time.

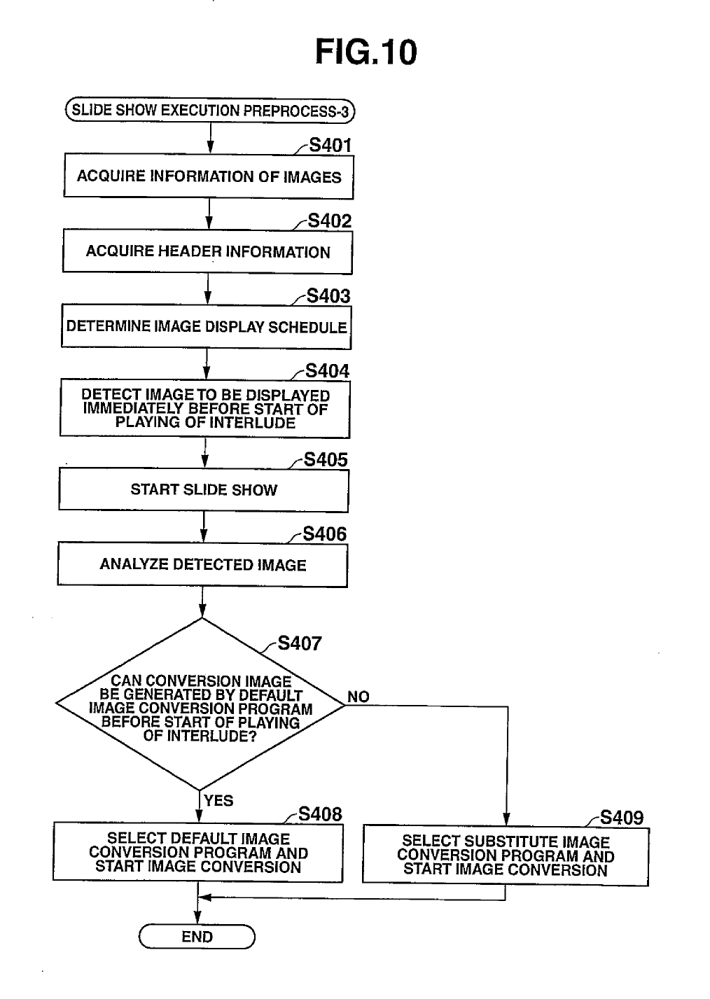

Next, a slide show execution preprocess-3 according to the third embodiment will be described with reference to FIG. 10. In the slide show execution preprocess-3, the preprocessing and the image analysis/program selection processing (see FIG. 9) are performed.

Step S401 (acquisition of information of images) to step S404 (detection of an image to be displayed immediately before a start of playing of the interlude) are the same as steps S101-S104 of the slide show execution preprocess-1 according to the first embodiment (see FIG. 4).

A slide show is started at step S405. That is, the image display processing and the sound output processing shown in FIG. 9 are started. More specifically, the same process as the slide show execution process-1 shown in FIG. 5 is started.

At step S406, the controller 10A (image analyzing section 15) analyzes the image that was detected at step S404. More specifically, the controller 10A converts the detected image into a vector image and detects the number U of units of vectors contained in the vector image. If one unit consists of 100 vectors and the vector image contains 3,000 vectors, the number of units of vector elements contained in the original image is equal to 30 (U=30). The number of vectors constituting one unit is a predetermined numerical value.

At step S407, the controller 10A judges, using the analysis result, whether or not a conversion image can be generated using a predetermined default image conversion program before a start of playing of the interlude. A specific judging method will be described, later.

If judging that a conversion image can be generated before a start of playing of the interlude (5407: yes), at step S408 the controller 10A selects the default image conversion program stored in the slide show execution program storage section 23. The controller 10A starts generation of a conversion image of the image detected at step S404 using the default image conversion program.

On the other hand, if judging that a conversion image cannot be generated before a start of playing of the interlude (S407: no), at step S409 the controller 10A selects a substitute image conversion program having a shorter processing time. A specific selection method will be described later.

The controller 10A starts generation of a conversion image of the image detected at step S404 using the selected image conversion program.

Upon completion of step S408 or S409, the slide show execution preprocess-3 is finished.

Since the slide show has already been started, no new slide show execution process is started.

Now, how step S407 (judgment as to whether or not a conversion image can be generated using the predetermined default image conversion program before a start of play of the interlude; see FIG. 10) and step S409 (selection of a substitute image conversion program; see FIG. 10) are executed will be described below in detail. These steps are executed on the basis of the image conversion program information.

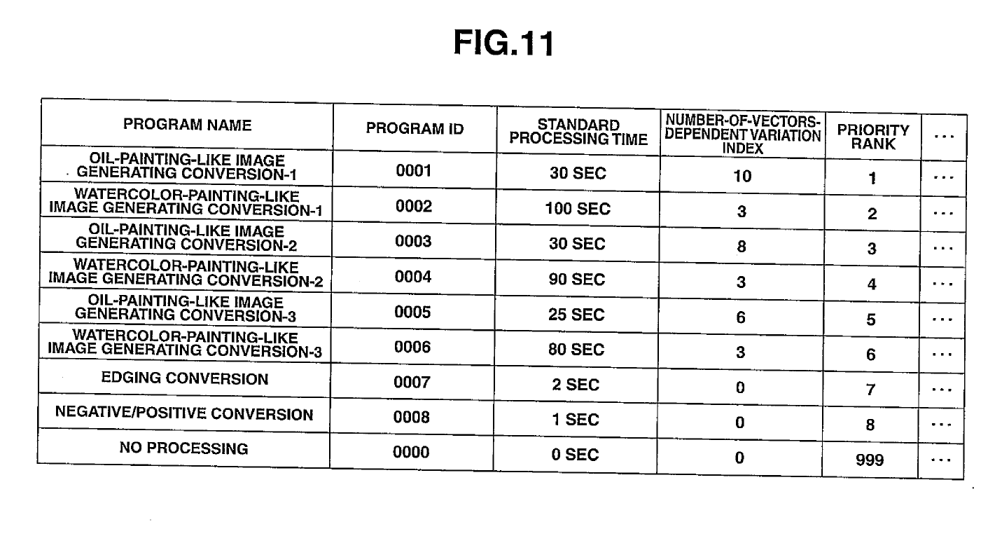

The structure of the image conversion program information used in the third embodiment will be described below with reference to FIG. 11. The image conversion program information used in the third embodiment is different from the image conversion program information used in the second embodiment in that a number-of-vectors-dependent variation index is set for each image conversion program.

In the image conversion program information used in the third embodiment, a program name, a program ID, a standard processing time, a priority rank, and a number-of-vectors-dependent variation index, etc. are correlated with each other for each image conversion program.

The program name is the name of the corresponding image conversion program.

The program ID is identification information (ID) that uniquely denotes the corresponding image conversion program.

The standard processing time is a basic processing time that is necessary for the corresponding image conversion program to perform image conversion processing.

The number-of-vectors-dependent variation index indicates to what extent the processing time that is necessary for the corresponding image conversion program to generate a conversion image increases per one unit of vector elements contained in a conversion source image. An estimated processing time PT of each image conversion program is calculated according to an equation PT=(standard processing time)+(variation index)×U.

The standard processing time and the variation index are values determined by experiments.

At step S907 (see FIG. 10), the controller 10A compares a time from the present time to the interlude start time with a time (margin-added processing time) obtained by multiplying the estimated processing time PT of the default image conversion program (i.e., the program having the priority rank “1”) by a safety factor. The safety factor is a numerical value that gives the processing time a certain margin and is determined in advance by an experiment.

If the margin-added processing time is shorter than the time from the present time to the interlude start time, the controller 10A judges that a conversion image can be generated in time (S407: yes).

On the other hand, if the margin-added processing time is longer than the time to the interlude start time, the controller 10A selects a substitute image conversion program at step S409. More specifically, margin-added processing times of image conversion programs, other than the default program, registered in the image conversion program information are determined and compared with the time to the interlude start time in descending order of the priority rank (i.e., in ascending order of the numerical value). As a result, an image conversion program having a highest priority rank among programs whose margin-added processing times are shorter than the time to the interlude start time is selected as a substitute program.

To provide for a case that the time to the interlude start time is very short, the image conversion program information includes a row of “no processing.” Such a row is always given a largest numerical value indicating a priority rank in the list.

According to the above-described third embodiment, even in the case where image conversion programs whose processing speeds vary to a large extent depending on the number of vectors are stored in the image conversion program storage section 24, an image conversion program that can generate a conversion image in time for prescribed timing by estimating image processing times.

This allows various image conversion program candidates to be stored in the image conversion program storage section 24 and used, and, in turn, makes it possible to generate conversion images in a wide variety of styles. As a result, the viewer may be surprised or interested. In this manner, it becomes possible to attract attention of the viewer.

Although the embodiments of the invention have been described above, the invention is not limited to the embodiments.

For example, in the above embodiments, the switching of the display image from an original image to a conversion image is made instantaneously. However, in the invention, the method of displaying a conversion image is not limited to this method.

For example, the switching to a final conversion image may be made gradually by inserting intermediate images.

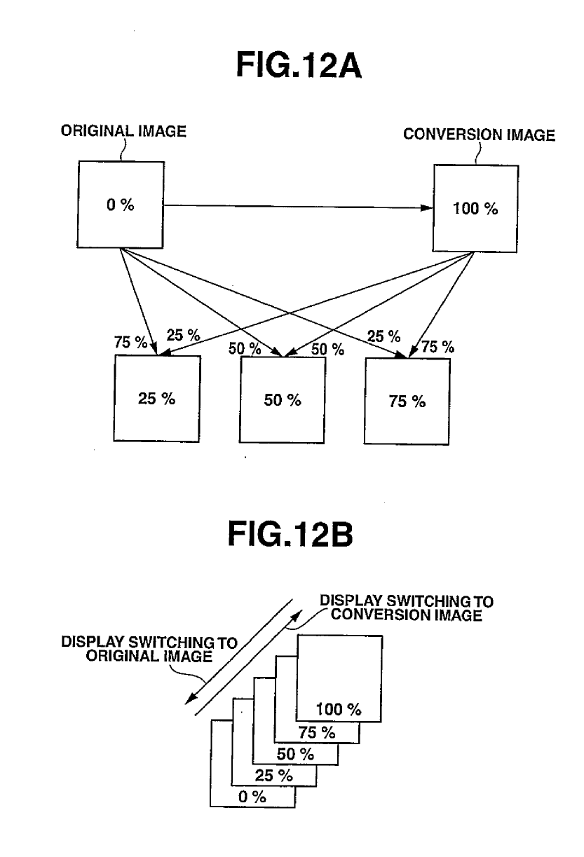

This type of processing will be described below with reference to FIGS. 12A and 12B. When a conversion image (the degree of conversion: 100%) has been generated by converting an original image (the degree of conversion: 0%), plural intermediate images are generated by combining the original image and the conversion image. In the example of FIGS. 12A and 12B, images having the degrees of conversion 25%, 50%, and 75% are generated by performing weighted averaging on the original image and the conversion image and then stored (see FIG. 12A). Each combined image (intermediate image) is generated by a known combined image generation program such as a program of performing weighted averaging on color values according to a combining ratio on a pixel-by-pixel basis.

As shown in FIG. 12B, when the interlude is started (time t4), the original image (the degree of conversion: 0%), the intermediate images having the degrees of conversion 25%, 50%, and 75%, and the conversion image (the degree of conversion: 100%) are displayed sequentially in this order. When switching is made to the original image (time t5), the conversion image (the degree of conversion: 100%), the intermediate images having the degrees of conversion 75%, 50%, and 25%, and the original image (the degree of conversion: 0%) are displayed sequentially in this order.

This makes it possible to cause the user to feel as if a transition were occurring from a photograph to a picture when the interlude is started.

Each of the display apparatus 1 to 3 may be configured so as to allow the user to freely make, for example, settings relating to the manner of execution of a slide show by, for example, manipulating the input unit 40 or the touch screen 30.

A modification is possible in which plural musical data are stored in the sound data storage section 21 in advance, one of the plural musical data is selected by the user or according to prescribed conditions in starting a slide show, and the slide show is performed using the selected sound data. Furthermore, images to be displayed in a slide show may be selected from the images stored in the image data storage section 22. Arbitrary methods for selecting musical data or images may be employed.

In this modification, the user may be allowed to freely set display order of images.

In this manner, the user can arbitrarily set and cause execution of a slide show that meets to his or her needs.

In the above embodiments, sounds to be played are represented by musical data which contains information indicating an interlude. However, the invention is not limited to such a case. Musical data without header information may be used. In this case, for example, the controller 10 or 10A may identify an interlude by extracting portions including human singing voices and portions not including human singing voices.

If musical data cannot be separated into an interlude and melody portions, one measure is to detect a time point of a melody change and display a conversion image at the detected time point.

Sounds to be generated are not limited to musical sound and may be other kinds of sounds such as human conversation voices.

In the above embodiments, one conversion image is displayed during playing of an interlude. However, plural conversion images may be displayed during playing of an interlude. In this case, conversion processing for generating plural conversion images to be displayed during playing of an interlude is performed in advance. It is also possible to display plural conversion images during play of plural respective interludes of a music.

Although the above embodiments are directed to the case of displaying a conversion image during play of an interlude of a music, the application range of the invention is not limited to such a case. The invention can broadly be applied to various situations in which a conversion image is displayed in a slide show with no preparatory work or waiting time.

For example, the invention can be applied to a display apparatus having a new notifying means and a timer function which performs a slide show using photographs until a prescribed time and starts display of, for example, a photograph as converted into an oil-painting-like image when the prescribed time is reached. The user can recognize passage of a preset time by display of the oil-painting-like image on the display screen.

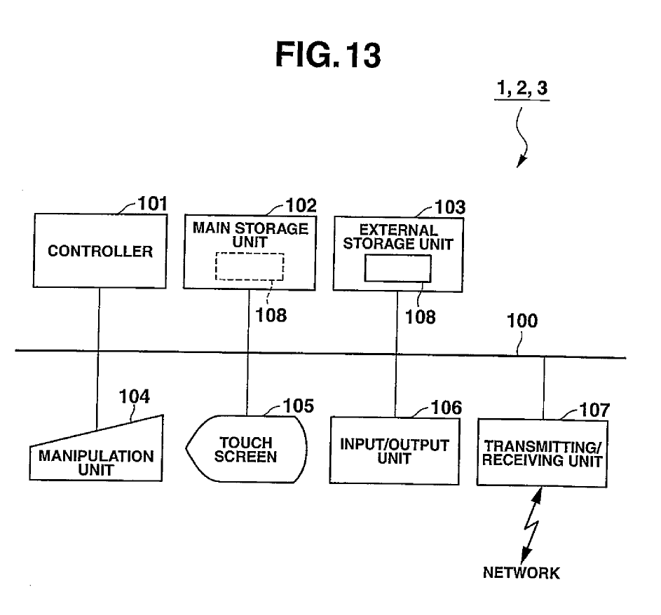

A specific hardware configuration of each of the display apparatus 1 to 3 according to the first to third embodiments of the invention will be described below with reference to FIG. 13.

Each of the display apparatus 1 to 3 is equipped with a controller 101, a main storage unit 102, an external storage unit 103, a manipulation unit 104, a touch screen 105, an input/output unit 106, and a transmitting/receiving unit 107.

The main storage unit 102, the external storage unit 103, the manipulation unit 104, the touch screen 105, the input/output unit 106, and the transmitting/receiving unit 107 are connected to the controller 101 by an internal bus 100.

The controller 101 is configured of a CPU, an image processing DSP, a sound signal processing DSP, etc., and operates as the controller 10 or 10A of each of the display apparatus 1 to 3 according to control programs stored in the external storage unit 103.

The main storage unit 102 is a RAM (random access memory) or the like. The control programs 108 are loaded into the main storage unit 102 from the external storage unit 103. The main storage unit 102 is also used as a work area of the controller 101.

The external storage unit 103 is a nonvolatile memory such as a flash memory or a hard disk drive, and is stored in advance with programs for causing the controller 101 to perform pieces of processing of each of the display apparatus 1-3. The external storage unit 103 supplies data to be used by those programs to the controller 101 according to instructions from the controller 101, and stores data supplied from the controller 101. The storage unit 20 of each of the display apparatus 1-3 is configured of the main storage unit 102 and the external storage unit 103.

The manipulation unit 104 is configured of keys provided in a cabinet or a keyboard, a pointing device such as a mouse, an interface device which connects the keyboard, the pointing device, etc. to the internal bus 100, and other components.

The touch screen 105 is configured of an LCD (liquid crystal display), and a pressure sensor or an electrostatic sensor, etc.

The input/output unit 106 is a serial interface or a parallel interface. Where the user connects an external device to the display apparatus 1, 2, or 3 for the purpose information exchange, the external device is actually connected to the input/output unit 106.

The transmitting/receiving unit 107 is configured of a network termination device or a wireless communication device to be connected to a network and a serial interface or a LAN (local area network) interface which is connected to the network termination device or the wireless communication device. The transmitting/receiving unit 107 sends information stored in the display apparatus 1, 2, or 3 to and receives information from another user over the network.

Pieces of processing of the controller 10 or 10A, the storage unit 20, the touch screen 30, the input unit 40, and the sound output unit 50 of each of the display apparatus 1-3 or the display apparatus according to each modification are performed in such a manner that the control programs 108 operate using the controller 101, the main storage unit 102, the external storage unit 103, the manipulation unit 104, the touch screen 105, the input/output unit 106, the transmitting/receiving unit 107, etc. as resources.

As an example of processing of an original image, the painterly conversion is described but the invention is not limited thereto. Other examples of processing are as follows: conversion of two-dimensional original image to an image which can be viewed like stereoscopic images; conversion of an original still image to an image which can be viewed like moving images; combining an original image and other image; cutting out main subject from an original image; and processing of recognizing a certain subject in an original image.

Furthermore, an original image may be moving image.

Furthermore, musical data has been described as an example of sound data, however, sound data is not limited thereto and may be data having timing signals which can be synchronized with a slide show, such as simple rhythms, recitation, or commentary.

Sound data may be configured of Musical Instrument Digital Interface (MIDI) data. As a timing to be synchronized, pieces of information indicating some milliseconds and some MIDI clocks from the beginning of the MIDI data are stored. A quarter-note length MIDI clock ticks is defined in the MIDI header. Therefore, if a time length required for the processing is known in advance or is assessed by analysis, the schedule for synchronization with the slide show can be set.

Another example of the timing signal other than the sound data is, for example, lighting signals for many light emitting diodes (LEDs) provided in a frame of a display apparatus for decoration. The LEDs are lit in synchronization with the slide show.

Although the preferred embodiments of the invention have been described above, the invention is limited to no particular embodiments and the scope of the invention encompasses the scope as defined by the claims and its equivalents.

What is claimed is:

1. A display apparatus comprising:
an image storage section that stores plural images;
an image conversion section that selects an image from among the plural images and obtains a conversion image—by converting the selected image;
a schedule setting section that sets a schedule indicating an order and timings of displaying the plural images stored in the image storage section and the conversion image obtained by the image conversion section;
a display section that sequentially displays the plural images and the conversion image in the order and the timings according to the schedule set by the schedule setting section; and
a controller that controls the image conversion section to complete the conversion of the selected image before a display start timing of the conversion image, the display start timing set by the schedule setting section.

2. The display apparatus according to claim 1,
wherein the image conversion section comprises plural conversion programs for respectively performing different conversion processing; and
wherein the display apparatus further comprises:
a judging section that judges whether or not image conversion of the selected image by a certain conversion program of the plural conversion programs is completed by the display start timing of the conversion image;
a selecting section that selects another conversion program of the plural conversion programs capable of completing image conversion of the selected image by the display start timing of the conversion image if a judgment result of the judging section is negative; and
a section that converts the selected image based on the another conversion program selected by the selecting section.

3. The display apparatus according to claim 1, further comprising a play section that plays a series of sound sequentially generated according to passage of time;
wherein the schedule setting section sets the schedule based on the series of sound.

4. The display apparatus according to claim 3,
wherein the play section plays, as the series of sound, musical sound sequentially generated based on a certain music and further comprises an interlude detecting section that detects an interlude portion of the music; and
wherein the schedule setting section sets the display start timing of the conversion image in a period when the play section is to play the interlude portion.

5. The display apparatus according to claim 1, wherein the controller controls the image conversion section to select, as an image to be converted, an image to be displayed immediately before a display start timing of the conversion image according to the schedule.

6. The display apparatus according to claim 1,
wherein the image conversion section is configured to obtain two types of conversion images of a first and a second conversion images, the first and the second conversion images being different in degrees of conversion; and
wherein the display section displays the second conversion image after displaying the first image.

7. A display method comprising:
generating signals in predetermined timings and outputting timing signals having a pausing interval for pausing outputting of the signals for a certain period;
sequentially selecting original images, from among plural original images, to be displayed in synchronization with the outputting of the timing signals;
displaying a conversion image obtained by converting an original image from among the selected original images in a specific output timing of the timing signals; and
displaying the selected original images in timings other than the specific output timing.

8. The display method according to claim 1,
wherein the timing signals include a series of sound signals sequentially generated according to passage of time.

9. The display method according to claim 7,
the conversion of the original image is performed during the pausing interval.

10. The display method according to claim 8,
wherein the sound signals include musical sound signals sequentially generated based on a certain music, and the pausing interval includes an interval of an interlude of the certain music.

11. The display method according to claim 8,
wherein the original image to be converted is selected from the plural original images based on a length of the pausing interval and a time length for converting the original image.

12. The display method according to claim 7,
wherein the conversion of the original image includes obtaining plural conversion images which are different from each other.

13. The display method according to claim 7,
wherein the conversion of the original image includes obtaining plural types of conversion images whose types are different from each other; and
wherein the types of conversion images are selected according to a length of the pausing interval and a time length for converting the original image.

14. The display method according to claim 8,
wherein the sequential selection of the original images to be displayed in synchronization with the outputting of the sound signals, the obtaining of the conversion image by converting the original image, the display of the conversion image in the specific output timing of the sound signals, and the display of the selected original images in timings other than the specific output timing are set in advance as a predetermined schedule.

15. The display method according to claim 7, further comprising receiving the plural original images via a connected network.

16. The display method according to claim 8, further comprising receiving the sound signals via a connected network.
